(19) United States
(12) Patent Application Publication
(10) Pub. No.: US 2010/0331745 A1
(43) Pub. Date: Dec. 30, 2010

(54) Reciprocating Tapping Device

(76) Inventor: Woody YAO, San Chung City (TW)

Correspondence Address: HDLS IPR Services, PO Box 220746, Chantilly, VA, 20153, US

(21) Appl. No.: 12/701,574

(22) Filed: Feb. 7, 2010

(30) Foreign Application Priority Data
Jun. 24, 2009 (TW) 098211322

(51) Int. Cl. A61H 23/02

(52) U.S. Cl. 601/101

(57) ABSTRACT

A reciprocating tapping device includes a casing, a motor, a power supply, a transmission portion and a tapping portion. The tapping portion is connected with and driven by the transmission portion. An eccentric shaft is connected with the transmission portion. The tapping portion has a reciprocating portion. The reciprocating portion is connected with two tapping bars. The bars extend out of the casing. The eccentric shaft can covert the circular motion of the motor to back-and-forth motion. Therefore, the tapping portion can move backwards and forwards and the two tapping bars can move backwards and forwards. A flat plate is disposed in the front and back of the reciprocating portion so as to pivotally hold the reciprocating portion. Therefore, the tapping portion can move backwards and forwards without any sideway motion.

### BACKGROUND OF THE INVENTION

1. Field of the Invention

The invention generally relates to a reciprocating tapping device. More particularly, the invention relates to a reciprocating tapping device, in which an eccentric shaft is used to covert the circular motion of the motor to back-and-forth motion. The tapping action of the reciprocating tapping device can make us healthier. Also, rigid plates and pins are used to prevent the sideway movement of the reciprocating portion.

2. Description of the Prior Art

With the advancement of technology, we have a higher living standard. Also, the advancement of medicine makes our life expectancy much longer.

However, most of us lack exercise, have a poor dietary habit and may sleep very late. All these reasons bring down our immunity level and many people may have poor health and even get sick.

Therefore, we should pay attention to our health and avoid illnesses.

It has been well known that tapping our body is a good way to enhance our health. In the selection of the tapping device that we use, we should pay attention to the type and ease of use.

In the Taiwan Patent No. M325,223, a centrifugal piece is connected with a motor to generate vibrations. However, it does not have any tapping function.

In the Taiwan Patent No. M320,388, a centrifugal piece is connected with a motor to generate vibrations and a rotational protruding piece is used. However, it does not have any tapping function.

In the Taiwan Patent application No. 86209 977, cogwheels are used to drive several transmission shafts to generate circular motion. However, it does not have any tapping function.

From the above, we can see that none of the devices of the prior art has a tapping function. Therefore, the devices of the prior art needs to be improved.

To eliminate the disadvantages of the devices of the prior art, the inventor has put a lot of effort into the subject and has successfully come up with the reciprocating tapping device of the present invention.

### SUMMARY OF THE INVENTION

An object of the present invention is to provide a reciprocating tapping device that uses the traditional tapping action to tap on human body. Therefore, it can make us healthier.

Another object of the present invention is to provide a reciprocating tapping device in which rigid plates and pins are used to prevent the sideway movement of the reciprocating portion. Therefore, the tapping portion would not move sideways.

A third object of the present invention is to provide a reciprocating tapping device in which the rigid plates and pins are quite rigid. Therefore, the tapping portion would not move sideways.

A fourth object of the present invention is to provide a reciprocating tapping device that is lightweight and has a low production cost. Also, the components of the reciprocating tapping device of the present invention are simple parts, such as plates and pins. The reciprocating tapping device does not have any complicated mechanical parts, such as cogwheels, transmission shafts or linear track. In this way, the structure of the reciprocating tapping device is simplified and the friction generated by the complicated mechanical parts may thus be avoided.

To reach these objects, the reciprocating tapping device of the present invention is disclosed. The reciprocating tapping device of the present invention comprises a casing, a motor, a power supply, a transmission portion and a tapping portion. The casing holds the motor, power supply, transmission portion and tapping portion. The power supply supplies electricity to the motor, which drives the eccentric shaft, which in turn drives the transmission portion. Then, the transmission portion drives the tapping portion. The tapping portion has a reciprocating portion. The reciprocating portion is driven by the eccentric shaft. The reciprocating portion is connected with two tapping bars. The bars extend out of the casing. The eccentric shaft can covert the circular motion of the motor to back-and-forth motion. Therefore, the tapping portion can move backwards and forwards and the two tapping bars can move backwards and forwards. A flat plate is disposed in the front and back of the reciprocating portion so as to pivotally hold the reciprocating portion. The plates are pivotally connected with the casing and the reciprocating portion through pins. The reciprocating portion can move backwards and forwards and the flat plates can prevent the sideway motion of the reciprocating portion. Therefore, the tapping portion can move backwards and forwards without any sideway motion.

### BRIEF DESCRIPTION OF THE DRAWINGS

FIG. 1 is a perspective view illustrating the reciprocating tapping device of the present invention without the casing.

FIG. 1A is a perspective view illustrating the transmission portion of the reciprocating tapping device.

FIG. 2 is a front view illustrating the reciprocating tapping device of the present invention.

FIG. 3 is a side view illustrating the reciprocating tapping device of the present invention.

FIG. 4 is an enlarged front view illustrating the flat plates of the reciprocating tapping device.

FIG. 5A is a top view illustrating the continuous tapping action of the reciprocating tapping device at a first status.

FIG. 5B is a top view illustrating the continuous tapping action of the reciprocating tapping device at a second status.

FIG. 5C is a top view illustrating the continuous tapping action of the reciprocating tapping device at a third status.

FIG. 5D is a top view illustrating the continuous tapping action of the reciprocating tapping device at a forth status.

FIG. 6A is a side view illustrating the continuous tapping action of the reciprocating tapping device at a first status.

FIG. 6B is a side view illustrating the continuous tapping action of the reciprocating tapping device at a second status.

FIG. 6C is a side view illustrating the continuous tapping action of the reciprocating tapping device at a third status.

FIG. 6D is a side view illustrating the continuous tapping action of the reciprocating tapping device at a forth status.

### DETAILED DESCRIPTION OF THE PREFERRED EMBODIMENTS

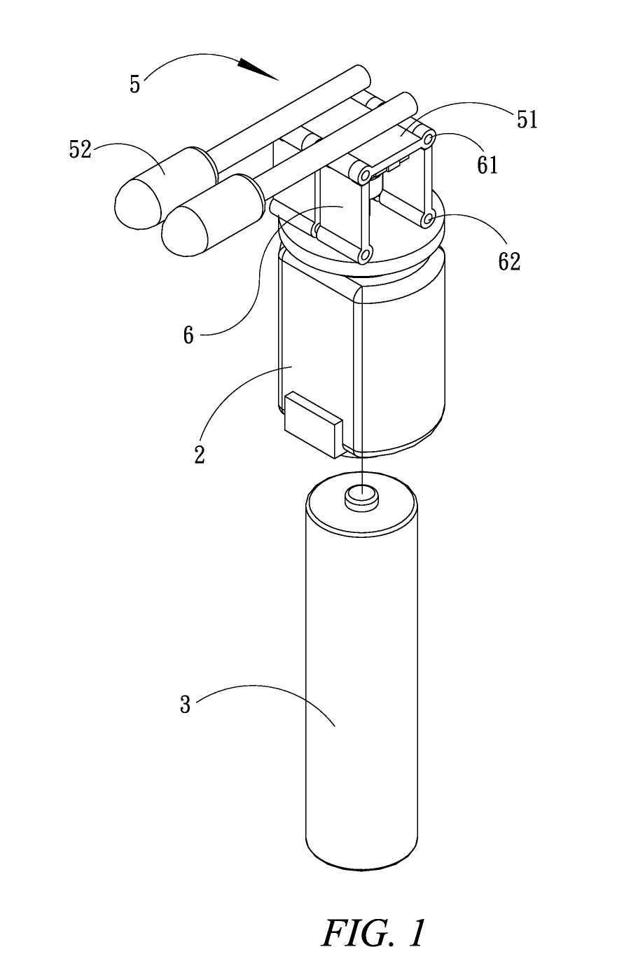

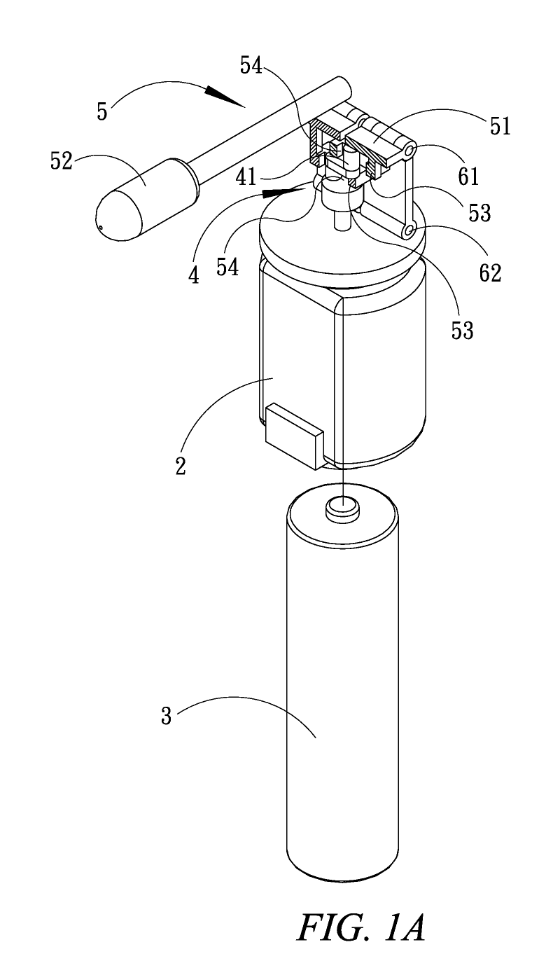

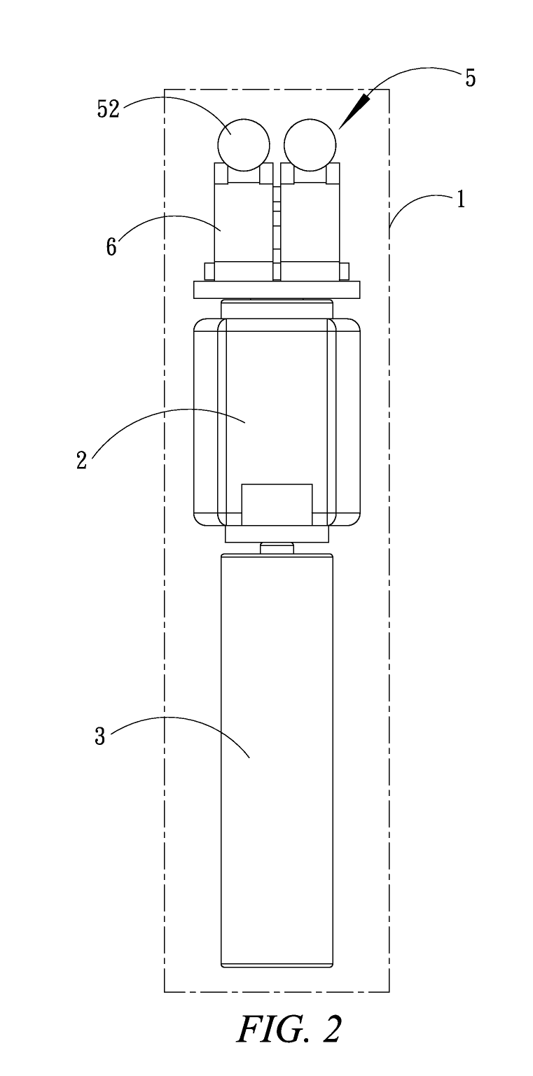

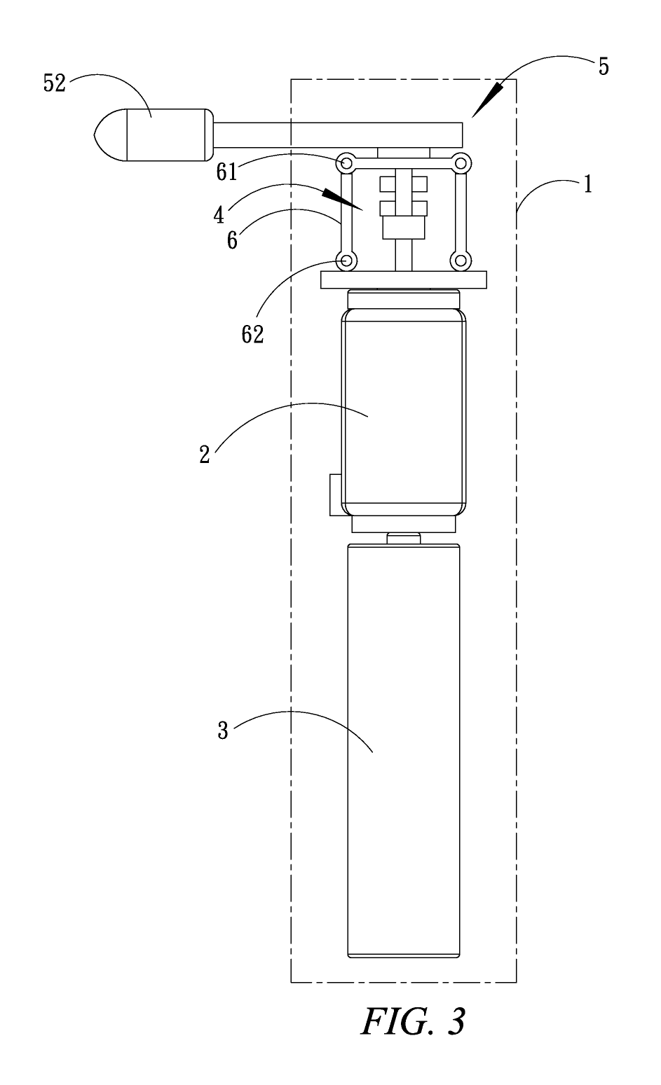

Please refer to FIGS. 1 to 4, which illustrate the reciprocating tapping device of the present invention. The reciprocating tapping device of the present invention comprises a casing 1, a motor 2, a power supply 3, a transmission portion 4 and a tapping portion 5.

The casing 1 holds the motor 2, power supply 3, transmission portion 4 and tapping portion 5. The power supply 3 supplies electricity to the motor 2. There is at least one set of tapping portion 5. The tapping portion 5 is connected with and driven by the transmission portion 4. An eccentric shaft 41 (please see FIG. 1A) is connected with the transmission portion 4. The motor 2 can drive the eccentric shaft 41. The eccentric shaft 4 can covert the circular motion of the motor 2 to backwards-forwards motion. Therefore, the tapping portion 5 can move backwards and forwards. The tapping portion 5 has a reciprocating portion 51. The reciprocating portion 51 is connected with two tapping bars 52. The bars 52 extend out of the casing 1. Therefore, the two tapping bars 52 can move backwards and forwards.

A connective portion 53 is disposed by the reciprocating portion 51 and a positioning slot 54 is disposed inside the connective portion 53. The positioning slot 54 has a rectangular shape and is oriented laterally. Because the eccentric shaft 41 passes through the positioning slot 54, the eccentric shaft 41 can move only within the positioning slot 54. In addition, the eccentric shaft 41 drives the reciprocating portion 51.

A flat plate 6 is disposed in the front and back of the reciprocating portion 51 so as to pivotally hold the reciprocating portion 51 and one end of each plate 6 is pivotally mounted on the casing 1. Because the plates 6 are quite rigid, they can hold the reciprocating portion 51 in position. Because the plates 6 are pivotally connected with the casing 1 and the reciprocating portion 51, the plates can move forwards and backwards. The plates 6 are pivotally connected with the casing 1 and the reciprocating portion 51 through pins 61 and 62. Other connective means may also be used.

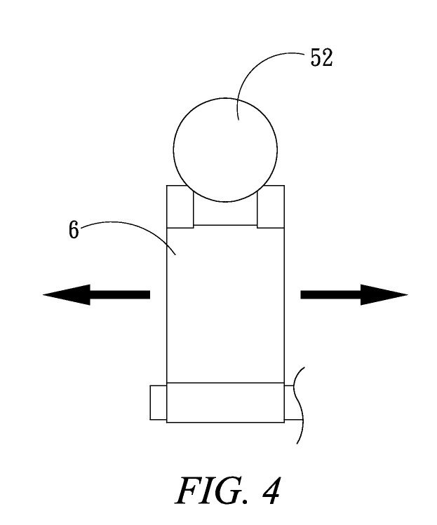

FIG. 4 further illustrates why the plates 6 are used. As the reciprocating portion 51 moves forwards and backwards, the reciprocating portion 51 may move sideways and this may affect the tapping action. Therefore, the rigid plates 6 are used to prevent such sideway movements.

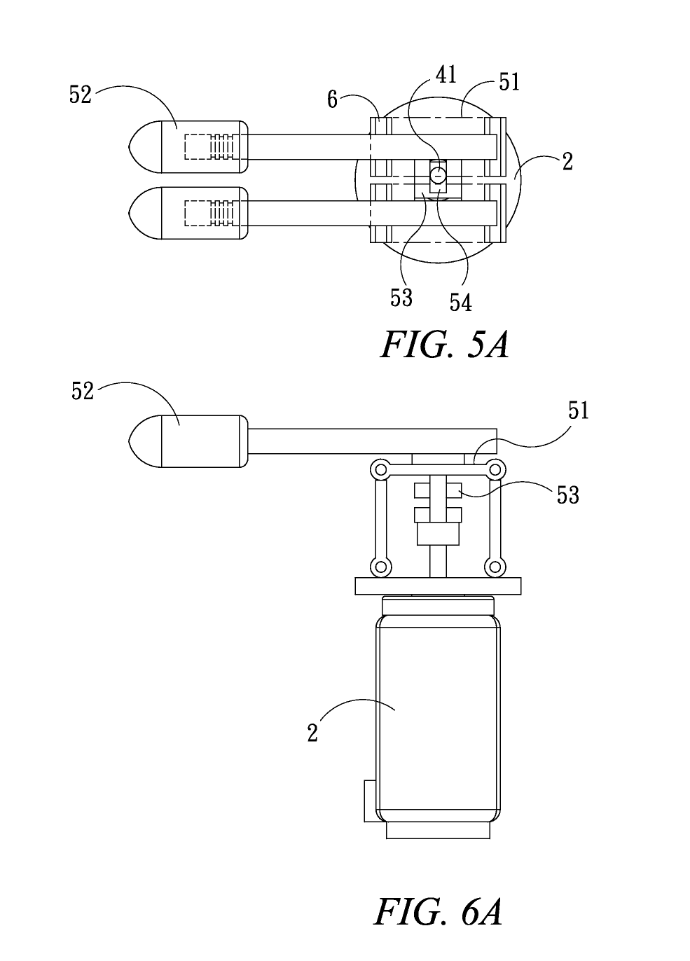

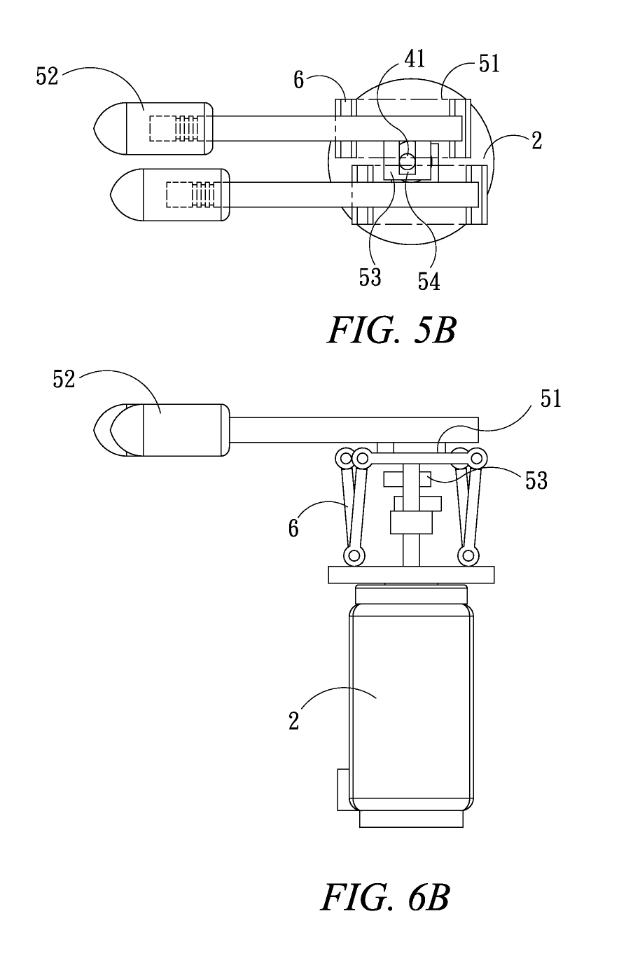

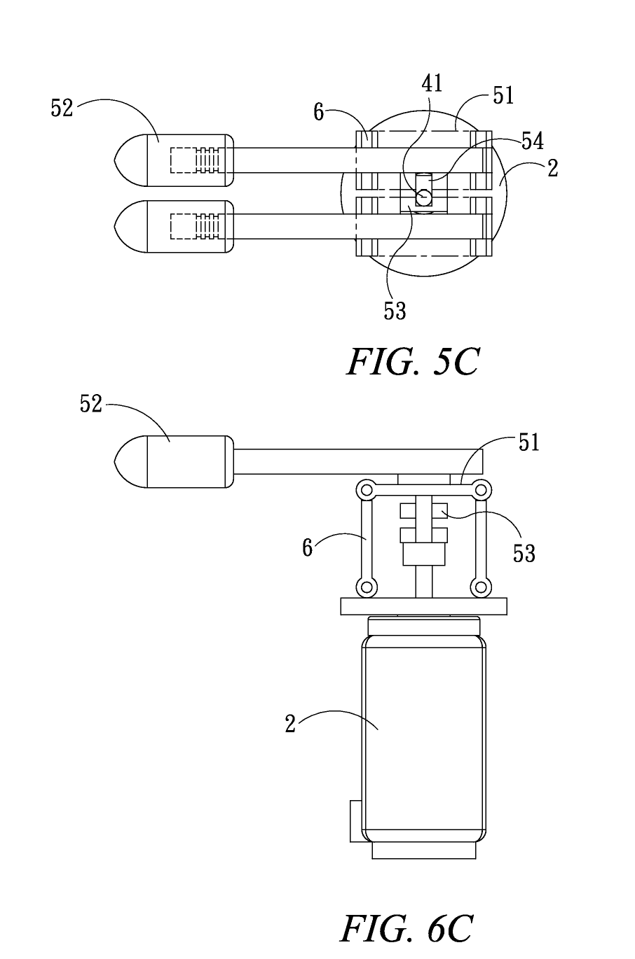

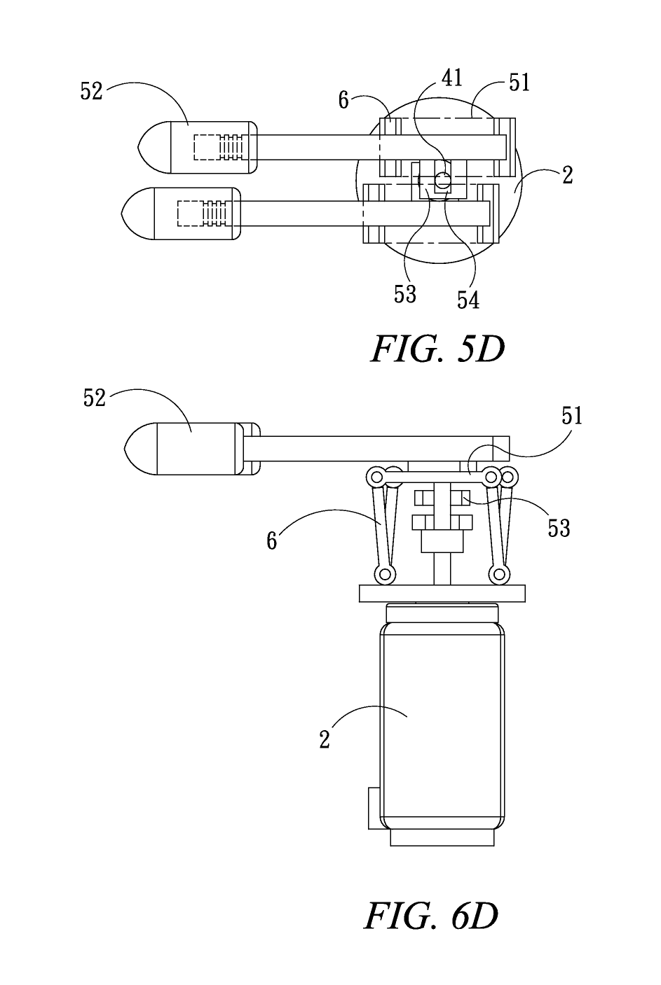

The continuous tapping action is illustrated from FIGS. 5A to 6D. There are at least one set of tapping portion 5. Alternatively, two sets of tapping portion 5 may be used. In such case, each set is disposed on one side of the transmission portion 4. The eccentric shaft 4 is connected with the tapping portion 5. The eccentric shaft 4 can covert the circular motion of the motor 5 to backwards-forwards motion. Therefore, the two tapping bars can tap on the user. In the similar manner, two sets of the tapping portion 5 may be used.

In comparison to the devices of the prior art, the reciprocating tapping device of the present invention has the following advantages:

1. The reciprocating tapping device of the present invention uses the traditional tapping action to tap on human body. Therefore, it can make us healthier.
2. The reciprocating tapping device of the present invention is lightweight and has a low production cost. It is easy to use and easy to carry around. Therefore, a user may use it at any time and place.
3. The components of the reciprocating tapping device of the present invention are simple parts, such as plates, pins and eccentric shaft. The reciprocating tapping device does not have any complicated mechanical parts, such as cogwheels, transmission shaft or linear track. In this way, the structure of the reciprocating tapping device of the present invention is simplified and the friction and noises generated by the complicated mechanical parts may thus be avoided.
4. The rigid plates are used to prevent the sideway movements the reciprocating portion. Therefore, the tapping portion would not move sideways.

Many changes and modifications in the above described embodiment of the invention can, of course, be carried out without departing from the scope thereof Accordingly, to promote the progress in science and the useful arts, the invention is disclosed and is intended to be limited only by the scope of the appended claims.

What is claimed is:

1. A reciprocating tapping device, comprising:
a casing;
a motor located in the casing;
a power supply, supplying electricity to the motor;
a transmission portion, driven by the motor; and
a tapping portion, wherein the transmission portion drives the tapping portion to carry out a reciprocating tapping action, and wherein an eccentric shaft is connected with the transmission portion and a reciprocating portion is disposed on the tapping portion, wherein the reciprocating portion is connected with two tapping bars, which extend out of the casing, and wherein the eccentric shaft can convert circular motion of the motor to back-and-forth motion and thus the eccentric shaft can drive the reciprocating portion to move backwards and forwards,
characterized in that a flat plate is disposed in front and back of the reciprocating portion so as to pivotally hold the reciprocating portion, and wherein one end of each plate is pivotally mounted on the casing and the plates can prevent the sideway movement of the reciprocating portion.

2. The reciprocating tapping device as in claim 1, wherein the plates are pivotally connected with the reciprocating portion through pins.

3. The reciprocating tapping device as in claim 1, wherein the plates are pivotally connected with the casing through pins.
